(19) United States
(12) Patent Application Publication
(10) Pub. No.: US 2024/0251183 A1
(43) Pub. Date: Jul. 25, 2024

(54) IMAGING ELEMENT AND RANGING DEVICE

(71) Applicant: Panasonic Intellectual Property Management Co., Ltd., Osaka (JP)

(72) Inventor: Yutaka HIROSE, KYOTO FU (JP)

(21) Appl. No.: 18/626,994

(22) Filed: Apr. 4, 2024

Related U.S. Application Data
(63) Continuation of application No. PCT/JP2022/036900, filed on Oct. 3, 2022.

(30) Foreign Application Priority Data
Oct. 6, 2021 (JP) 2021-164681

(51) Int. Cl. H04N 25/709; G01S 17/894; H04N 25/76

(52) U.S. Cl. CPC H04N 25/709; G01S 17/894; H04N 25/7795

(57) ABSTRACT

A distance measurement device includes a plurality of pixels. Each of the pixels includes a light-receiving element, a capacitor, and a constant current source device that outputs a constant current to the capacitor from the start of exposure of the pixel until light is detected by the light-receiving element.

### CROSS-REFERENCE OF RELATED APPLICATIONS

This application is a Continuation Application of International Patent Application No. PCT/JP2022/036900, filed on Oct. 3, 2022, which in turn claims the benefit of Japanese Patent Application No. 2021-164681, filed on Oct. 6, 2021, the entire disclosures of which Applications are incorporated by reference herein.

### TECHNICAL FIELD

The present disclosure relates to an imaging element and a distance measurement device.

### BACKGROUND ART

There are distance measurement devices and systems which use pixel arrays including a plurality of single-photon avalanche diodes (SPADs) to measure a distance to a subject.

For example, the distance measurement device of Patent Document 1 includes: a pulse light source that emits light signals; a detector array including a single-photon detector that outputs detection signals indicating the respective arrival times of a plurality of incoming photons; and a processing circuit that receives the detection signals. The processing circuit includes: a correlator circuit configured to output respective correlation signals representing the detection of one or more of photons having arrival times within a predetermined correlation time with respect to each other; and a time processing circuit including a counter circuit configured to increment a count value based on the respective correlation signals or detection signals and a time integrator circuit configured to generate an integrated time value.

### CITATION LIST

### Patent Document

Patent Document 1: Japanese Translation of PCT International Application No. 2021-513087

### SUMMARY OF THE INVENTION

### Technical Problem

However, in Patent Document 1, each pixel needs to have a counter circuit and a time integrator circuit (see FIG. 19 of Patent Document 1), resulting in a larger circuit size per pixel.

An objective of the present disclosure is to provide an imaging element with a smaller size per pixel and a distance measurement device.

### Solution to the Problem

To achieve the above objective, an imaging element according to an embodiment of the present disclosure includes a plurality of pixels, each of the plurality of pixels including: a light-receiving element; a storage element; and a constant current source device configured to output a constant current to the storage element from the start of exposure of the pixels to the end of the exposure.

### Advantages of the Invention

According to the present disclosure, it is possible to reduce the size per pixel.

### BRIEF DESCRIPTION OF THE DRAWINGS

FIG. 1 is a block diagram illustrating an example of a general configuration of a distance measurement device according to a first embodiment.

FIG. 2 is a block diagram illustrating a configuration of a light-receiving sensor according to the first embodiment.

FIG. 3 is a diagram illustrating a circuit formed in a pixel according to the first embodiment.

FIG. 4 is a timing diagram related to a distance measurement operation of a pixel according to a first embodiment in one frame period.

FIG. 5 is a block diagram illustrating a configuration of a readout circuit according to the first embodiment.

FIG. 6 is a diagram for illustrating a principle of distance measurement by a distance measurement device according to the second embodiment.

FIG. 7 is a diagram for illustrating a method of generating a sub-range image according to the second embodiment.

FIG. 8 is a diagram illustrating a circuit formed in a pixel according to the second embodiment.

FIG. 9 is a timing diagram related to a distance measurement operation of a pixel according to the second embodiment in one frame period.

### DESCRIPTION OF EMBODIMENTS

Embodiments of the present invention will be described in detail below with reference to the drawings. The following description of advantageous embodiments is only an example in nature, and is not intended to limit the scope, applications or use of the present disclosure.

### First Embodiment

### -General Configuration of Distance Measurement Device-

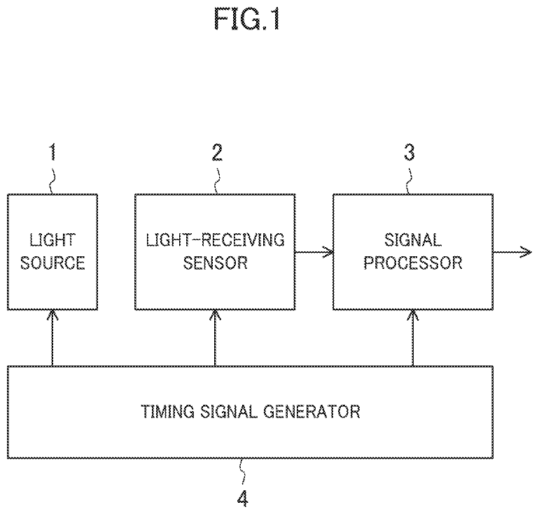

FIG. 1 is a block diagram illustrating an example of a general configuration of a distance measurement device according to a first embodiment. As illustrated in FIG. 1, the distance measurement device according to the present embodiment includes a light source 1, a light-receiving sensor 2, a signal processor 3, and a timing signal generator 4.

The light-receiving sensor 2 receives light emitted by the light source 1 and reflected off a subject. The light-receiving sensor 2 outputs an output signal indicating the result of the light receiving to the signal processor 3.

The signal processor 3 calculates the distance to the subject based on the signal received from the light-receiving sensor 2. The signal processor 3 outputs a signal indicating the calculation result.

The timing signal generator 4 outputs, to the light source 1, the light-receiving sensor 2, and the signal processor 3, signals indicating their respective drive timings. Specifically, the timing signal generator 4 outputs a signal synchronized in phase with the frame rate of the light-receiving sensor 2 so that the light source 1, the light-receiving sensor 2, and the signal processor 3 operate in a manner in which all pixels are exposed simultaneously (global shutter). The frequencies of the signals output by the timing signal generator 4 may differ from each other.

### -Configuration of Light-Receiving Sensor-

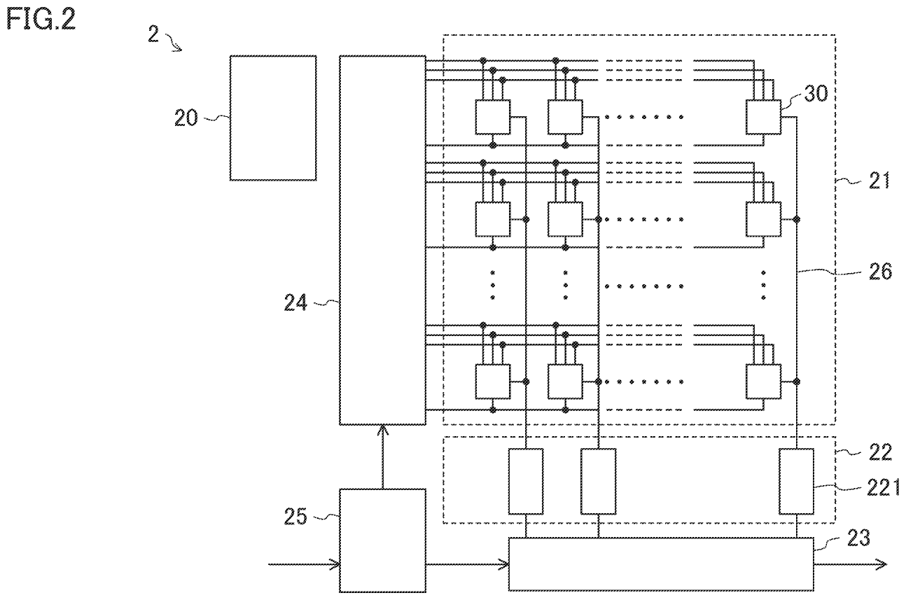

FIG. 2 is a block diagram illustrating a configuration of the light-receiving sensor according to the first embodiment. As illustrated in FIG. 2, the light-receiving sensor 2 includes a bias generator circuit 20, a pixel array 21, a readout circuit 22, a horizontal output circuit 23, a vertical drive circuit 24, and a sensor timing generator 25.

The bias generator circuit 20 supplies a bias signal (details are omitted) necessary to drive the light-receiving sensor 2. The bias signal may be supplied externally.

The pixel array 21 includes a plurality of pixels 30 arranged in an array. In the plurality of pixels 30, a row selection signal V_{SEL}, a reset signal V_{RST}, a PD bias control signal V_{D}, and a constant current source bias signal V_{I} are supplied for each row. Each of the pixels 30 outputs a pixel signal indicating a detection result to an output line 26 in accordance with the row selection signal V_{SEL}, the reset signal V_{RST}, the PD bias control signal V_{D}, and the constant current source bias signal V_{I}, which have been supplied.

The readout circuit 22 includes a plurality of column circuits 221. Each of the column circuits 221 has an amplifier and an AD converter, described below. The column circuit 221 is provided for each column of the plurality of pixels 30. The readout circuit 22 reads out the signals output from each of the pixels 30 via the output line 26, using the column circuit 221.

The horizontal output circuit 23 sequentially outputs, as output signals, the signals output from the readout circuit 22.

The vertical drive circuit 24 generates the row selection signal V_{SEL}, the reset signal V_{RST}, the PD bias control signal V_{D}, and the constant current source bias signal V_{I} and outputs these signals to the respective pixels 30 at predetermined timing.

The sensor timing generator 25 outputs a drive timing signal indicating the drive timing of each of the horizontal output circuit 23 and the vertical drive circuit 24.

### -Configuration of Pixel-

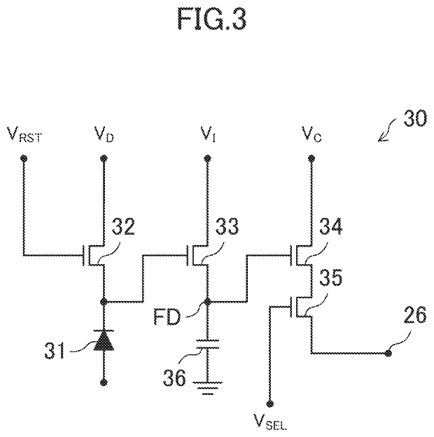

FIG. 3 is a diagram illustrating a circuit formed in a pixel according to the first embodiment. As illustrated in FIG. 3, the pixel 30 includes a light-receiving element 31, a reset transistor 32, a constant current source transistor 33, a source follower transistor 34, a selection transistor 35, and a capacitor 36.

The light-receiving element 31 is, for example, a photodiode (PD), such as a SPAD or an avalanche photodiode (APD), and has an anode terminal to which a high voltage of −20 V is supplied from an external source.

The reset transistor 32 has: the source (or drain) that receives the PD bias control signal V_{D}; the drain (or source) to which a cathode terminal of the light-receiving element 31 and the gate of the constant current source transistor 33 are connected; and the gate that receives the reset signal V_{RST}.

The constant current source transistor 33 has the source (or drain) that receives the constant current source bias control signal V_{I}, and the drain (or source) to which floating diffusion (FD) is connected.

The source follower transistor 34 has: the source (or drain) to which a pixel power supply bias signal V_{C} is connected; the drain (or source) to which the source (or drain) of the selection transistor 35 is connected; and the gate to which the FD is connected.

The selection transistor 35 has the drain (or source) to which the output line 26 is connected, and the gate that receives the selection signal V_{SEL}.

The capacitor 36 has one end connected to the FD and the other end connected to the ground voltage (earth).

The constant current source transistor 33 is set to a floating state during an exposure period. At this time, charge corresponding to the distance of the subject is stored in the capacitor 36. The source follower transistor 34 outputs the pixel signal corresponding to the charge stored in the capacitor 36 to the output line 26 when the selection transistor 35 is turned on.

### -Operation of Pixel-

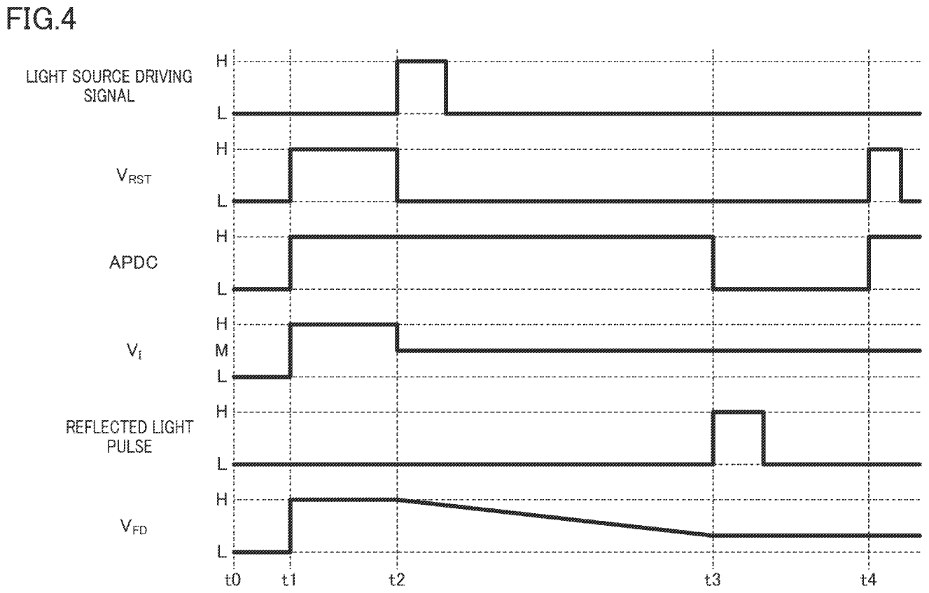

FIG. 4 is a timing diagram related to a distance measurement operation of a pixel according to the first embodiment in one frame period. In the present embodiment, a laser pulse is used as the light source 1, and a result of the distance measurement by a single shot of laser pulse is regarded as one frame. FIG. 4 shows, from the top to the bottom, a driving signal (exposure start signal) for the light source 1 (laser pulse), the reset signal V_{RST}, a cathode voltage APDC of the light-receiving element 31, the constant current source bias signal V_{I}, a reflected light pulse signal (exposure-end signal) output when the light-receiving sensor 2 receives reflected light, and an FD voltage V_{FD} which indicates a voltage level of the capacitor 36. The driving signal for the light source 1 is generated by the vertical drive circuit 24 having received a signal from the timing signal generator 4. The reflected light pulse signal is set to become high level at the timing when the light-receiving element 31 detects light. The signals and voltages are typically 3 V at high level (H) and 0 V at low level (L).

It is assumed that one frame period starts at initial time to.

At time t1, the reset signal V_{RST} and the PD bias control signal V_{D} become high level. Accordingly, the reset transistor 32 is turned on, and the cathode voltage APDC of the light-receiving element 31 becomes high level, allowing a reset of the light detection signal and dark current component of the previous frame.

Further, at time t1, the constant current source bias control signal V_{I} becomes high level. Since the cathode voltage APDC of the light-receiving element 31 is high level, the gate of the constant current source transistor 33 is also high level at this moment, which makes the FD voltage V_{FD} high level.

At time t2, driving of the light source 1 starts, and the reset signal V_{RST} becomes low level. The constant current source bias control signal V_{I} is set to middle level (M) between the high level and the low level so that a subthreshold voltage is output from the drain of the constant current source transistor 33. Here, V_{H}−V_{M}<Vₜₕ is satisfied, where the subthreshold voltage of the constant current source transistor 33 is Vₜₕ, the voltage at high level is V_{H}, and the voltage at middle level is V_{M}. Accordingly, from time t2 to time t3, the constant current source transistor 33 is biased in a subthreshold region and thus operates as a constant current source using the constant current source bias control signal V_{I} as the source. As a result, the FD voltage V_{FD} decreases in potential in proportion to time, due to the injection of the constant current from the constant current source transistor 33.

At time t3, when the light-receiving sensor 2 receives reflected light (when the reflected light pulse signal is high level), the light-receiving element 31 (e.g., a SPAD) detects the reflected light, and a Geiger mode pulse is generated. Since the reset transistor 32 is off at this moment, self-quenching of the light-receiving element 31 occurs, and the cathode voltage APDC of the light-receiving element 31 drops to low level due to charges generated by the avalanche multiplication. Accordingly, the constant current source transistor 33 is turned off, and the injection of charges to the FD is stopped.

At time t4, the reset signal V_{RST} becomes high level, and the reset transistor 32 is thus turned on. The injection of charges to the capacitor 36 thus stops in all the pixels 30.

A readout period starts after time t4: Signals output from the pixels 30 are read out by the readout circuit 22, and the pixels 30 enter a standby state until the start of the next frame.

### -Configuration of Readout Circuit-

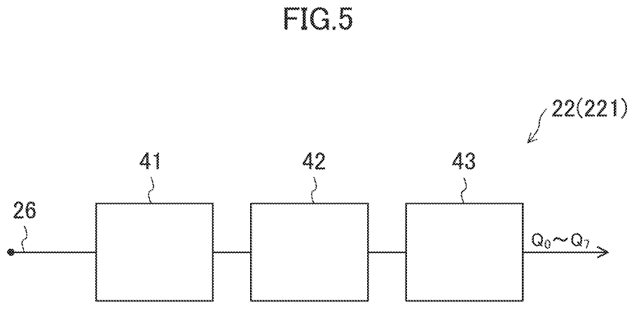

FIG. 5 is a block diagram illustrating a configuration of the readout circuit according to the first embodiment. As illustrated in FIG. 5, the column circuit 221 of the readout circuit 22 includes a column amplifier circuit 41, a correlated double sampling (CDS) circuit 42, and a single slope AD converter (SSADC) 43.

The column amplifier circuit 41 is connected to the output line 26 and amplifies an output signal output from each pixel 30.

The CDS circuit 42 outputs the difference between the output signal amplified by the column amplifier circuit 41 and a zero level signal read out beforehand.

The single slope AD converter 43 converts the signal output from the CDS circuit 42 into an 8-bit digital signal (Q0 to Q7) and outputs the 8-bit digital signal to the horizontal output circuit 23.

Here, the current I output to the FD by the constant current source transistor 33 from time t2 to time t3 is expressed as follows:

$$I = {I}_{0} \cdot exp ( a ψ ) \qquad [ Math 1 ]$$

Here, ψ is the surface potential barrier generated from the source to the gate of the constant current source transistor 33, and determined by V_{H}−V_{M}<Vₜₕ. The I₀ is a constant determined by the surface impurity concentration and the size of the device. Further, a is a temperature-dependent constant.

The distance resolution in the present embodiment is shown below. As described above, the CDS circuit 42 eliminates the switching noise of the capacitor 36, and a noise limit value is determined by shot noise of the constant current source transistor 33 as the current source. If the distance to the nearest subject is Zₘᵢₙ and the light speed constant is c, the flight (exposure) time Δtₘᵢₙ from when the light source 1 emits the laser pulse to when the light-receiving sensor 2 detects the light reflected by the subject is 2. Zₘᵢₙ/C. Accordingly, the charges stored in the capacitor 36 in the exposure period is expressed as follows:

$$2 \cdot {I}_{0} \cdot exp ( a ψ ) \cdot {z}_{min} / c \qquad [ Math 2 ]$$

The shot noise relating to the charge amount is the square root thereof; therefore, a signal-to-noise ratio (S/N ratio) is also given by the square root. Accordingly, the minimum amount required as a signal in this example is S/N>1:

$$\sqrt{2 \cdot {I}_{0} \cdot exp ( a ψ ) \cdot {z}_{min} / c} > 1 \qquad [ Math 3 ]$$

For example, in the following case,

$${I}_{0} \cdot exp ( a ψ ) = 1.5 \times 1 {0}^{- 9} A \qquad [ Math 4 ]$$

Zₘᵢₙ=1.6 cm, which is small enough to be practical.

As described above, the distance measurement device according to the first embodiment enables high-precision imaging for distance measurement of the entire range through an intra-pixel time-to-digital converter (TDC) operation simultaneously in all the pixels in the same frame.

The distance measurement device according to the first embodiment includes a plurality of pixels 30. Each of the pixels 30 includes the light-receiving element 31, the capacitor 36 (storage element), and the constant current source transistor (constant current source device) that outputs a constant current to the capacitor 36 from the start of exposure of the pixel 30 until light is detected by the light-receiving element 31. It is therefore possible to measure the distance to the subject through measurement of charges stored in the capacitor 36. It is also possible to reduce the size per pixel because it is no longer necessary to provide a counter circuit or a time integrator circuit for each pixel. Since the size per pixel is smaller, it is possible to increase the number of pixels, the entirety of which is capable of simultaneous distance measurement.

The light-receiving element 31 is an avalanche photodiode. The antenna sensitivity of the light-receiving sensor 3 can thus be improved, thereby making it possible to measure a longer distance. The S/N ratio in the TDC operation can also be improved, thereby making it possible to improve the distance resolution.

### Second Embodiment

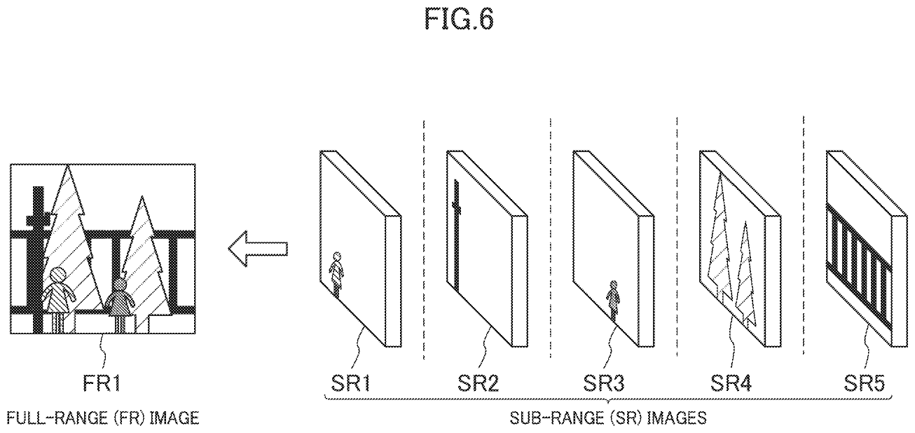

FIG. 6 is a diagram for illustrating a principle of distance measurement by a distance measurement device according to a second embodiment. The distance measurement device according to the second embodiment can generate sub-range (SR) images SR1 to SR5 and a full-range (FR) image FR1 including the sub-range images SR1 to SR5. In the following description, the same reference characters as those in the above embodiment may be used to represent equivalent configurations, and the detailed explanation thereof may be omitted.

For example, the flight time (the time from when light is emitted from the light source 1 to when the light reflected by the subject returns to the light-receiving sensor 2) varies depending on the distance from the light source 1 to the subject. A subject at a predetermined distance can be detected by setting the exposure time in the light-receiving sensor 2 based on the flight time.

In the second embodiment, the exposure time for each sub-range is set to a timing delayed, from when the light source emits light, by a round-trip flight time of the distance corresponding to the center position between previous and following sub-ranges (for example, the sub-range images SR2 and SR4 in the case of the sub-range image SR3). The exposure based on the exposure time is repeated (i.e., the returning light (photons) are counted), which makes it possible to obtain the photon count value at a position corresponding to each sub-range. When the count value exceeds a certain threshold value, the light-receiving sensor 2 outputs a signal of a predetermined output level, considering that there is a subject, and generates an image of that sub-range. The light-receiving sensor 2 generates a full-range image FR1 by superimposing a plurality of sub-range images obtained (sub-range images SR1 to SR5 in FIG. 6).

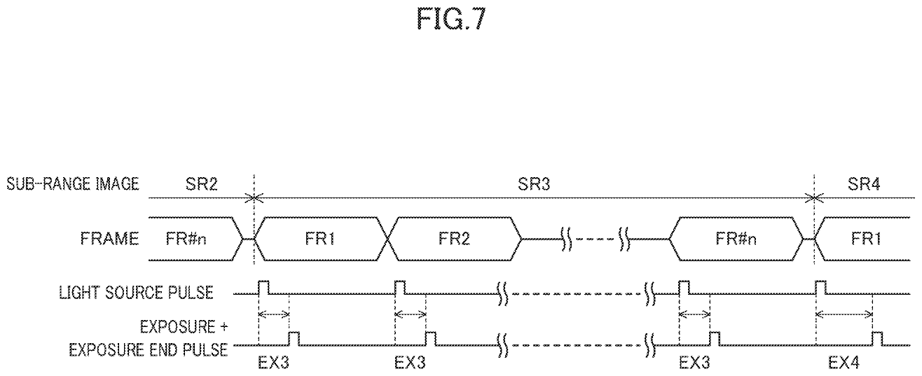

FIG. 7 is a diagram for illustrating a method of generating a sub-range image according to the second embodiment. FIG. 7 shows a generation timing of the sub-range image SR3.

As illustrated in FIG. 7, in the second embodiment, an exposure+exposure-end pulse (a pulse whose rising corresponds to the start of exposure and whose falling corresponds to the end of the exposure) is generated at a timing delayed by time EX3 (distance measurement period), which is a time equivalent to the flight time corresponding to the sub-range image SR3, from when light (pulse) is emitted from the light source 1. In other words, the light-receiving sensor 2 causes the exposure in the period when the exposure+exposure-end pulse is high to generate the sub-range image SR3. The light-receiving sensor 2 performs this exposure operation multiple times (frames, n times in this example) to create the sub-range image SR3 and counts the number of photons reflected back from the subject.

### -Configuration of Pixel-

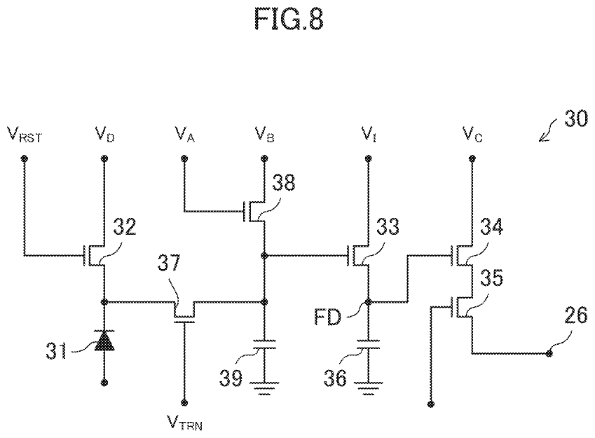

FIG. 8 is a circuit configuration of a pixel according to the second embodiment. As illustrated in FIG. 8, in the second embodiment, the pixel 30 further includes a charge transfer transistor 37, a constant current source control transistor 38, and a signal charge storage capacitor 39. The configuration of light-receiving sensor 2 is substantially the same as that in FIG. 2, and the description thereof is omitted.

The charge transfer transistor 37 has: the source (or drain) to which the drain (or source) of the reset transistor 32 and a cathode of the light-receiving element 31 are connected; the drain (or source) to which the gate of the constant current source transistor 33, the drain (or source) of the constant current source control transistor 38, and one end of the signal charge storage capacitor 39 are connected; and the gate that receives a charge transfer gate signal V_{TRN}. The signal charge storage capacitor 39 has the other end connected to the ground voltage.

The constant current source transistor 33 has the source (or drain) that receives the constant current source bias signal V_{I}, and the drain (or source) to which floating diffusion (FD) is connected.

The constant current source control transistor 38 has the source (or drain) that receives a constant current source control signal VB and the gate that receives a signal charge capacitor reset signal V_{A}.

The charge transfer gate signal V_{TRN} and the constant current source control signal VB are generated by the vertical drive circuit 24.

### -Operation of Pixel-

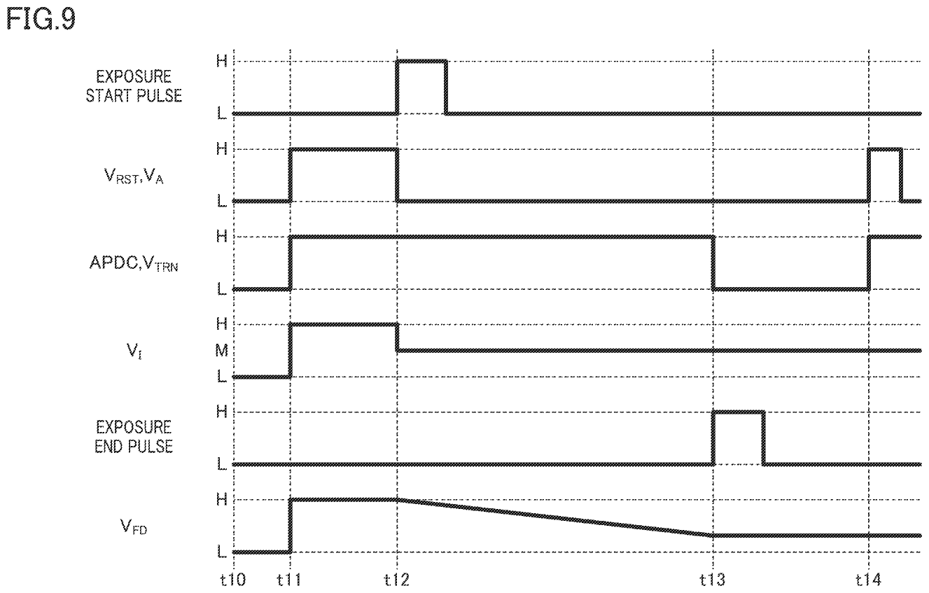

FIG. 9 is a timing diagram related to a distance measurement operation of a pixel according to the second embodiment in one frame period. The exposure start pulse (exposure start signal) is generated by the vertical drive circuit 24 having received a signal from the timing signal generator 4. As mentioned in the above description, the exposure start pulse is generated (becomes high level) at the timing delayed by the time (distance measurement period) equivalent to the flight time corresponding to the sub-range image, from when light (pulse) is emitted from the light source 1. The exposure end pulse signal is set to become high level at the timing when the light-receiving element 31 detects light.

In the second embodiment, similarly to the first embodiment, a laser pulse is used as the light source 1, and a result of the distance measurement by a single shot of laser pulse is regarded as one frame. Distance measurement is performed the number of times that is the predetermined number of frames, in one sub-range. Signal charges proportional to both the number of times of photon detection in that period and the distance of the subject are stored in the capacitor 36, and the pixel 30 outputs the result to the signal line 26 as a pixel signal.

It is assumed that one frame period starts at initial time t10.

At time t11, the reset signal V_{RST}, the PD bias control signal V_{D}, and the charge transfer gate signal V_{TRN} become high level. Accordingly, the reset transistor 32 and the charge transfer transistor 37 are turned on, and the cathode of the light-receiving element 31 becomes high level, allowing a reset of the light detection signal and dark current component of the previous frame.

Further, at time t11, the constant current source bias control signal V_{I} becomes high level. The gate of the constant current source transistor 33 is also high level at this moment, which makes the FD voltage V_{FD} high level.

At time t12, the exposure start pulse (the pulse indicating the exposure start timing in generating the sub-range image) becomes high level, and the reset signal V_{RST} becomes low level. The constant current source bias control signal V_{I} is set to middle level between the high level and the low level so that a subthreshold voltage is output from the drain of the constant current source transistor 33. Here, V_{H}−V_{M}<Vₜₕ is satisfied, where the subthreshold voltage of the constant current source transistor 33 is Vₜₕ, the voltage at high level is V_{H}, and the voltage at middle level is V_{M}. Accordingly, from time t12 to time t13, the constant current source transistor 33 operates as a constant current source using the constant current source bias control signal V_{I} as the source. As a result, the FD voltage V_{FD} decreases in potential in proportion to time, due to the injection of the constant current from the constant current source transistor 33.

At time t13, when the light-receiving sensor 2 receives reflected light (when the reflected light pulse signal is on), the light-receiving element 31 (e.g., a SPAD) detects the reflected light, and a Geiger mode pulse is generated. Since the reset transistor 32 is off at this moment, self-quenching of the light-receiving element 31 occurs, and the cathode voltage APDC of the light-receiving element 31 drops to low level due to charges generated by the avalanche multiplication. Accordingly, the constant current source transistor 33 is turned off, and the injection of charges to the FD is and therefore to the capacitor 36 stopped.

At time t14, the reset signal V_{RST} becomes high level, and the reset transistor 32 is thus turned on. The distance measurement of one frame thus stops in all the pixels 30.

A readout period starts after time t14: Signals output from the pixels 30 are read out by the readout circuit 22, and the pixels 30 enter a standby state until the start of the next frame.

As described above, according to the distance measurement device of the second embodiment, it is possible to distinguish the timing at which the light-receiving sensor 2 receives photons, thereby making it possible to improve the resolution of the sub-range image. Similarly to the first embodiment, the pixels can perform the TDC operation in the second embodiment, as well, which enables mode switching between the sub-range image generation and the TDC operation.

### Other Embodiments

In the foregoing description, the embodiments serve as examples of the technique disclosed in the present application. However, the technique in the present disclosure is not limited to the embodiments, and is also applicable to embodiments where modifications, substitutions, additions, or omissions are made appropriately.

In each of the above embodiments, a case in which the constant current source device is the constant current source transistor 33 has been described as an example. However, the constant current source device is not limited thereto, and any configuration is applicable as long as a constant current can be injected into the capacitor 36. For example, the constant current source device may be configured as a low voltage and a resistor.

### DESCRIPTION OF REFERENCE CHARACTERS

1 Light Source
2 Light-Receiving Sensor
3 Signal Processor
4 Timing Generator
30 Pixel
31 Light-Receiving Element
33 Constant Current Source Transistor (Constant Current Source Device)
36 Capacitor (Storage Element)

1. An imaging element comprising:
a plurality of pixels, each of the plurality of pixels including:
a light-receiving element;
a storage element; and
a constant current source device in each of the plurality of pixels, the constant current source device being configured to output a constant current to the storage element from start of exposure of the pixel until light is detected by the light-receiving element.

2. The imaging element of claim 1, wherein
the constant current source device stops the output of the constant current in accordance with a change in a voltage of an output terminal of the light-receiving element.

3. The imaging element of claim 1, wherein
the constant current source device includes a constant current source transistor with a gate connected to an output terminal of the light-receiving element, and
the constant current source transistor is biased in a subthreshold region during the output of the constant current.

4. The imaging element of claim 1, wherein
each of the plurality of pixels undergoes exposure multiple times per frame and outputs a signal indicating a charge stored in the storage element as a result of the multiple times of exposure.

5. The imaging element of claim 1, wherein
the light-receiving element is an avalanche photodiode.

6. The imaging element of claim 5, wherein
the avalanche photodiode operates in a Geiger mode upon detection of light.

7. A distance measurement device comprising:
the imaging element of claim 1;
a light source;
a timing signal generator configured to output, to the plurality of pixels, an exposure start signal indicating a timing of the start of exposure; and
a signal processor configured to calculate a measurement distance to a subject, from a pixel signal output from each of the plurality of pixels.

8. The distance measurement device of claim 7, wherein
the timing signal generator outputs the exposure start signal when a flight time corresponding to a predetermined distance has elapsed since the light source emitted light.
